(19) United States
(12) Patent Application Publication
(10) Pub. No.: US 2025/0337843 A1
(43) Pub. Date: Oct. 30, 2025

(54) IMAGE PROCESSOR, IMAGE PROCESSING METHOD, AND NON-TRANSITORY RECORDING MEDIUM

(71) Applicant: Yuya Itoh, KANAGAWA (JP)

(72) Inventor: Yuya Itoh, KANAGAWA (JP)

(73) Assignee: Ricoh Company, Ltd., Tokyo (JP)

(21) Appl. No.: 19/169,207

(22) Filed: Apr. 3, 2025

(30) Foreign Application Priority Data
Apr. 30, 2024 (JP) 2024-073473

(51) Int. Cl. H04N 1/00; G06T 7/90; G06V 10/60

(52) U.S. Cl. CPC H04N 1/00018; G06T 7/90; G06V 10/60; H04N 1/00084; H04N 1/00803

(57) ABSTRACT

An image processor includes circuitry configured to obtain a scanned image from a scanner; detect a missing area of the document in the scanned image; determine a background color of the document in the scanned image; and determine whether to use the background color of the document as an interpolation color for interpolating the missing area of the document in the scanned image.

### CROSS-REFERENCE TO RELATED APPLICATIONS

This patent application is based on and claims priority pursuant to 35 U.S.C. § 119(a) to Japanese Patent Application No. 2024-073473, filed on Apr. 30, 2024, in the Japan Patent Office, the entire disclosure of which is hereby incorporated by reference herein.

### BACKGROUND

### Technical Field

The present disclosure relates to an image processor, an image processing method, and a non-transitory recording medium.

### Related Art

In an image processing apparatus, a technique for repairing a missing portion included in a read document is known. A technique related to an image processing apparatus that replaces a missing portion of a document in a scanned image with a background color of the document is known.

For example, when the entire document to be read is not included in the scanned image, the document may be read again. When the missing portion of the document included in the scanned image is replaced with the background color of the document, it may be difficult to visually confirm that the missing portion is included in the output image.

### SUMMARY

An embodiment of the present disclosure provides an image processor comprising circuitry configured to: obtain a scanned image from a scanner; detect a missing area of the document in the scanned image; determine a background color of the document in the scanned image; determine whether to use the background color of the document as an interpolation color for interpolating the missing area of the document in the scanned image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram of a hardware configuration diagram of an image processing apparatus;

FIG. 2 is a schematic diagram of a configuration of a scanner included in the image processing apparatus of FIG. 1;

FIG. 3 is a block diagram of a functional configuration of the image processing apparatus in FIG. 1;

FIG. 4 is a diagram for describing a method for calculating angular information and coordinate information in the image processing apparatus of FIG. 1;

FIGS. 5A and 5B are diagrams for describing a method of interpolating a missing area of a document in the image processing apparatus of FIG. 1;

FIG. 6 is a flowchart of missing area interpolation processing in the image processing apparatus of FIG. 1;

FIG. 7 is a flowchart of missing area interpolation processing in an image processing apparatus;

FIG. 8 is a flowchart of missing area interpolation processing in an image processing apparatus;

FIG. 9 is a diagram for describing a method of calculating the size of a missing area in the image processing apparatus of FIG. 8;

FIG. 10 is a flowchart of missing area interpolation processing in an image processing apparatus; and

FIG. 11 is a diagram for explaining a method of determining a color for interpolating a missing area of a document based on presence or absence of printing at the end of a scanned image.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, an image processing apparatus is proved to facilitate the determination of whether a document has any missing portion in a scanned image.

Embodiments for implementing the disclosure are described below referring to the drawings. Like reference signs are applied to identical or corresponding components throughout the drawings and redundant description may be omitted.

### First Embodiment

### Configuration of Image Processing Apparatus 1

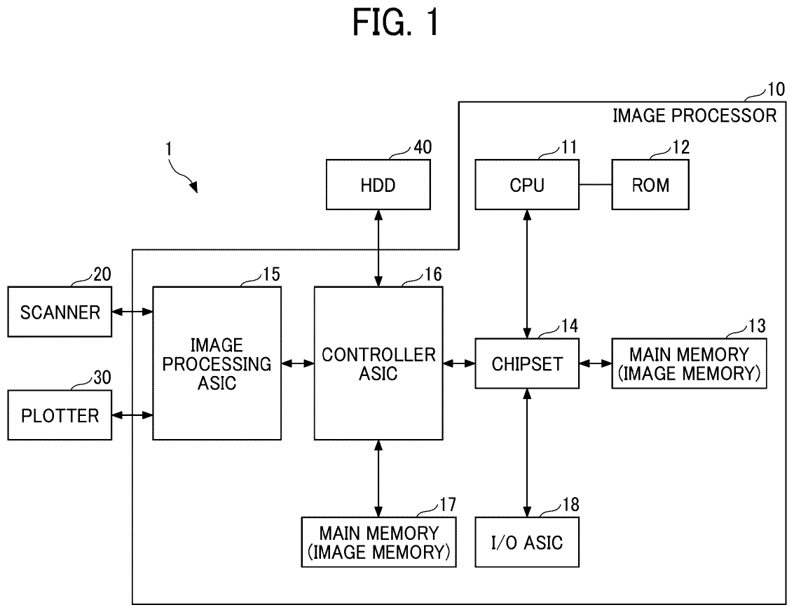

FIG. 1 is a block diagram of a hardware configuration diagram of an image processing apparatus 1 according to a first embodiment of the present disclosure. The image processing apparatus 1 includes an image processor 10, a scanner 20, a plotter 30, and a hard disk drive (HDD) 40. The image processing apparatus 1 may be, for example, a multifunction peripheral (MFP) with printer, copier, and fax functions, or an electronic device with a printer's image-forming function. The image processing apparatus is referred to also as an image forming apparatus.

The image processor 10 performs predetermined processing on the document image scanned by the scanner 20. The image processor 10 the scanner 20 and an automatic document feeder (ADF) form a skew detection device and a reading device.

The above-described configuration is adopted in the case of a scanner alone, but a plotter 30 for outputting an image onto a printing medium may be provided to enable copying and printing.

The image processor 10 includes a central processing unit (CPU) 11, a read only memory (ROM) 12, a main memory 13, a chip set 14, an image processing application specific integrated circuit (ASIC) 15, a controller ASIC 16, a main memory 17, and an input/output (I/O) ASIC 18.

The CPU 11 controls the image processing apparatus 1. The ROM 12 is a nonvolatile memory such as a flash memory, and stores a program. The main memory 13 is used as a work area in which a program for controlling the image processing apparatus 1 is developed by the CPU 11. The main memory 13 temporarily stores data such as a scanned image which is an image obtained by reading a document. The chip set 14 is used together with the CPU 11 and controls access to the main memory 13 by the controller ASIC 16 and the I/O ASIC 18.

The program executed by the image processing apparatus 1 may be stored in a computer readable storage medium, such as a compact disc read only memory (CD-ROM), a flexible disk (FD), a compact disc recordable (CD-R), and a digital versatile disc (DVD), in an installable or executable file format for distribution.

Furthermore, the program executed in the information processing apparatus 1 may be stored in a computer connected to a network such as the Internet and provided by downloading via the network. Further, the computer program executed in the information processing apparatus 1 may be provided or distributed via a network such as the Internet.

The scanner 20 performs processing such as copying and outputting a scanned image obtained from a scanned document to an external interface. The plotter 30 has a function to print the scanned image processed by the controller ASIC 16.

The image processing ASIC 15 performs image processing on image data read by the scanner 20 and outputs the processed image data to the controller ASIC 16. The image processing ASIC 15 processes the scanned image received from the controller ASIC 16 to enable the plotter 30 to print the scanned image. Further, the image processing ASIC 15 transmits the scanned image in accordance with the printing timing of the plotter 30.

The controller ASIC 16 uses the main memory 13 to rotate and edit the scanned image. The controller ASIC 16 stores the scanned image in a hard disk drive (HDD) 40 and exchanges the scanned image with the image processing ASIC 15.

The main memory 17 serves as an image memory for the controller ASIC 16 to process a scanned image. The HDD 40 temporarily stores the scanned image after image processing.

The interface (I/F) ASIC 18 serves as an external interface to provide additional features to the image processing apparatus 1. The additional features include interfaces such as a network interface, a universal serial bus (USB), a secure digital (SD) card, an operation unit, a serial peripheral interface (SPI), an inter-integrated circuit (I2C), and a document width sensor (or width detection sensor) interfaces, a hardware accelerator that accelerates image processing, and an encryption processing circuit.

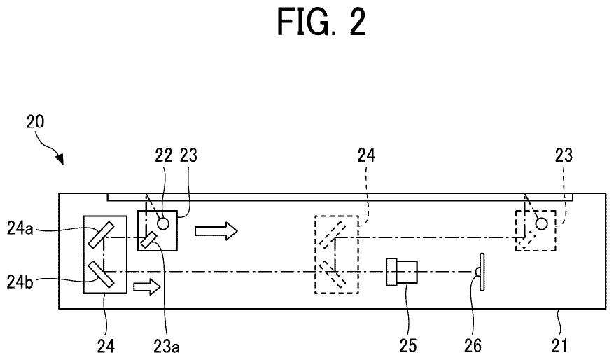

FIG. 2 is a schematic diagram of a configuration of a scanner 20 included in the image processing apparatus according to the first embodiment. Inside a body frame 21 of the scanner 20, a first rail and a second rail extend in a sub-scanning direction (or a horizontal direction in the drawing). The first rail includes two rails arranged at a predetermined interval in a main scanning direction orthogonal to the sub-scanning direction. The second rail has the same configuration as the first rail.

The scanner 20 includes a first carriage 23, a second carriage 24, an imaging lens 25, and an imager 26. These components are disposed inside the body frame 21 of the scanner 20.

The first carriage 23 is slidably mounted on the first rail, and reciprocates in the sub-scanning direction via a first carriage drive wire controlled by a drive motor. The first carriage 23 includes a light source 22 and a first mirror 23a.

The second carriage 24 is slidably mounted on the second rail, and reciprocates in the sub-scanning direction via a second carriage drive wire controlled by the drive motor. The second carriage 24 includes a second mirror 24a and a third mirror 24b.

The first carriage 23 and the second carriage 24 move in the sub-scanning direction at a speed ratio of 2:1. With this speed ratio between the first carriage 23 and the second carriage 24, the optical path length from the document surface to the imaging lens 25 remains constant irrespective of their movement.

The imaging lens 25 captures and focuses light reflected from the document through the mirrors, forming an image of the reflected light on the imager 26. The imager 26 includes an image sensor such as a charge-coupled device (CCD) and photoelectrically converts the reflected light image of the document, formed through the imaging lens 25, into an analog image signal as the scanned image.

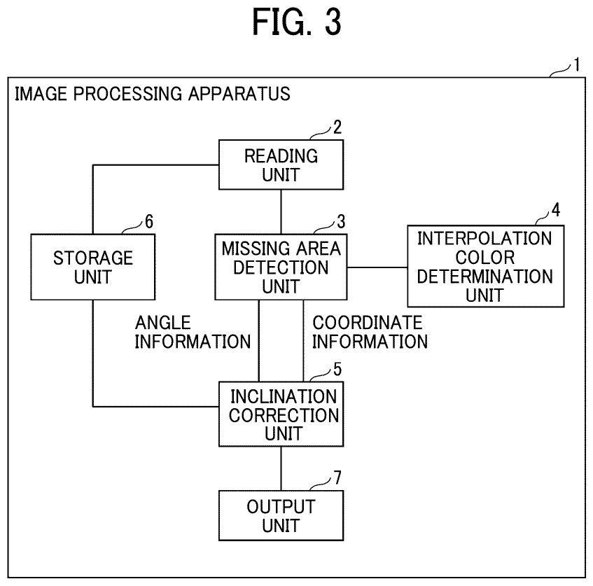

FIG. 3 is a block diagram of a functional configuration of the image processing apparatus 1 in FIG. 1. The image processing apparatus 1 includes a reading unit 2, a missing area detection unit 3, an interpolation color determination unit 4, an inclination correction unit 5, a storage unit 6, and an output unit 7.

The reading unit 2 scans a document. The reading unit 2 corresponds to the scanner 20 and the plotter 30, but is not limited thereto, and may be various reading units. The reading unit 2 stores a scanned image, which is an image obtained by scanning a document, in the storage unit 6.

The missing area detection unit 3 detects a missing area of the document included in the scanned image. The missing area detection unit 3 acquires angle information indicating the inclination of the document relative to the horizontal component of the scanned image, as well as coordinate information indicating the vertex coordinates of the document, and outputs this information to the inclination correction unit 5. In the following description, the missing area of the document may be simply referred to as a “missing area”.

The interpolation color determination unit 4 determines whether the color used to interpolate the missing area of the document is set as a background color of the document in the scanned image.

The inclination correction unit 5 corrects the inclination of the document based on the angle information relative to the horizontal component of the scanned image. The inclination correction unit 5 corrects the inclination of the scanned image stored in the storage unit 6 based on the coordinate information, and transmits the corrected image to the output unit 7.

The storage unit 6 stores the scanned image and the image corrected by the inclination correction unit 5. The output unit 7 outputs the scanned image and the corrected scanned image.

### Method for Calculating Angle Information and Coordinate Information

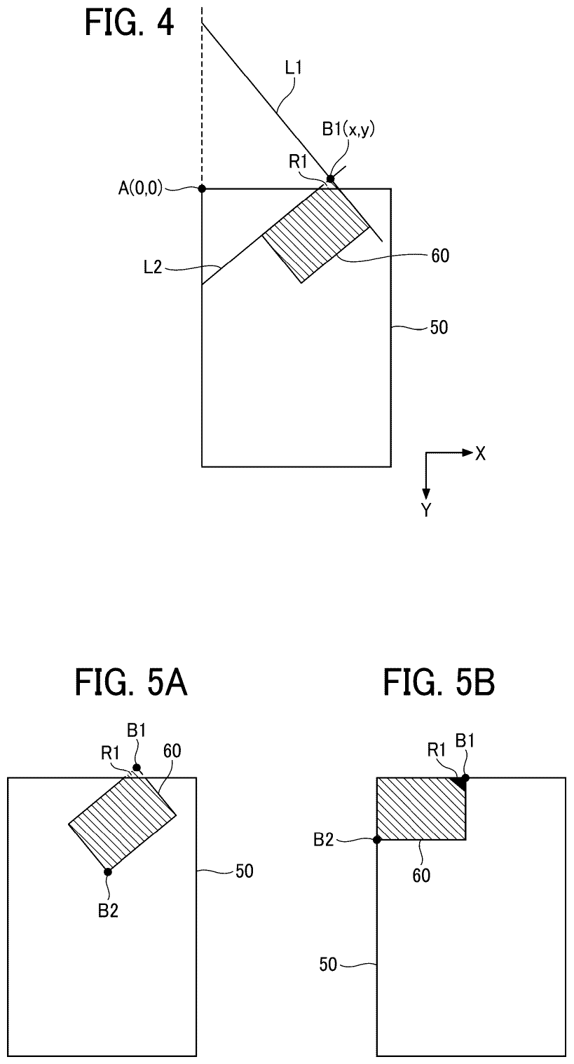

FIG. 4 is a diagram for describing a method for calculating angular information and coordinate information in the image processing apparatus 1 according to the first embodiment in FIG. 1. As illustrated in FIG. 4, a scanned image 50 and a document 60 are rectangular, and the scanned image 50 includes the document 60. A missing area R1, which is a part of the document 60, extends beyond the scanned image 50. The missing area R1 of the document 60 is a triangular area corresponding to the portion that extends beyond the scanned image 50. The shapes of the scanned image 50 and the document 60 are not limited to rectangles, and may include various shapes, such as squares.

For clarity, the following description uses an XY orthogonal coordinate system. The coordinates of vertex A, which is one end of the boundary of the scanned image 50 on the side where the missing area R1, a part of the document 60, extends beyond the scanned image 50, are set to (0,0). The coordinates of vertex B1 included in the missing area R1 of the document 60 are set to (x, y). As illustrated in FIG. 4, when the vertex B1 is included in the document 60, y is less than 0 (y<0).

In FIG. 4, a straight line L1 is a line that includes one side passing through the vertex B1 of the document 60, and a straight line L2 is a straight line including the other side passing through the vertex B1 of the document 60. The intersection of the straight lines L1 and L2 coincides with the vertex B1 of the document 60, and its coordinates (x, y) represent coordinate information.

The straight line L1 and the straight line L2 are each represented as a linear function y=ax+b using constants a and b in the XY orthogonal coordinate system. The constant a represents the slope of the straight line L1 and the straight line L2, and the constant b represents the y-intercept. The constant a is the inclination of the document 60 relative to the horizontal component of the scanned image 50 and serves as angle information.

The constants a and b are obtained by determining the boundary between the scanned image 50 and the document 60 based on the edge intensity, which indicates the degree of edge for each pixel value of the scanned image 50. Then, the equation of the straight line is derived using the least squares method based on the coordinates determined as the edge.

FIGS. 5A and 5B are diagrams for describing a method of interpolating a missing area R1 of a document 60 in the image processing apparatus 1 of FIG. 1. FIG. 5A illustrates a document 60 including a missing area R1 in a scanned image 50. FIG. 5B illustrate a scanned image 50 in which the missing area R1 of the document 60 has been interpolated. The vertex B1 of the document 60 is within the missing region R1, and a vertex B2 is included in the scanned image 50 and not adjacent to the vertex B1.

FIG. 5 indicates the document 60 with its inclination corrected by the inclination correction unit 5.

As in the example of FIG. 5B, the missing area R1 of the document 60A may be interpolated with black. By interpolating the missing area R1 with black, the user can easily recognize that a part of the document 60 is missing in the scanned image 50.

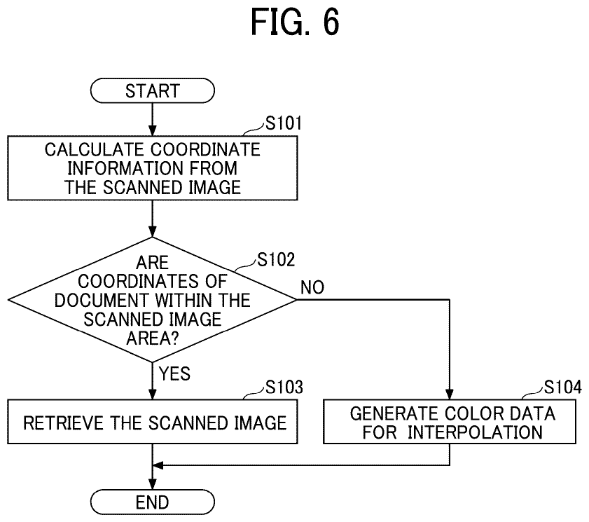

FIG. 6 is a flowchart of missing area interpolation processing in an image processing apparatus 1 according to the first embodiment. The following processing is performed by the CPU 11 of the image processor 10 in the image processing apparatus 1, indicating that the processing is executed by circuitry. In step S101, the image processing apparatus 1 calculates the coordinate information of the scanned image 50. The coordinate information may be calculated by setting the coordinates of the vertex A of the scanned image 50 to (0,0), for example. At this time, for example, when the angle information is 0° and the coordinate information is (0,0), the vertex B1 of the document 60 and the vertex A of the scanned image 50 coincide.

When the coordinates of the document 60 are within the scanned image 50 (Yes in step S102), the image processing apparatus 1 retrieves the scanned image 50 from a memory address corresponding to the calculated coordinates of the document 60 in the storage unit 6 (step S103).

When the coordinates of the document 60 are not within the scanned image 50 (No in step S102), the interpolation color determination unit 4 generates color data to interpolate the missing area R1 (step S104). Specifically, the missing area R1 is present when either x or y of the coordinate information (x, y) of the document 60 is negative. In this case, the interpolation color determination unit 4 generates a color to interpolate the missing area R1 and outputs it.

Specifically, whether the coordinates of the document 60 are within the readable area or not is determined by calculating the corresponding coordinates in the scanned image 50 based on the corrected coordinates as illustrated in FIG. 5B. If the calculated coordinates exceed the range of the scanned image 50, the coordinates of the document 60 are considered outside the readable area.

The color used to interpolate the missing area R1 may be black but is not limited thereto. For example, since the background color of the document 60 is often white, as in facsimile transmission, using black to interpolate the missing area R1 allows the user to easily determine whether any part of the document 60 is missing.

However, when the scanned image 50 is output for copying, missing a part of the document 60 may not be a concern. At this time, using white, which is the same as the background color of the document, to interpolate the missing area R1 provides good image quality and leads to lower ink consumption.

The image processing apparatus 1 of the present disclosure facilitates the user's determination of whether a document 60 has any missing portion in a scanned image 50.

### Second Embodiment

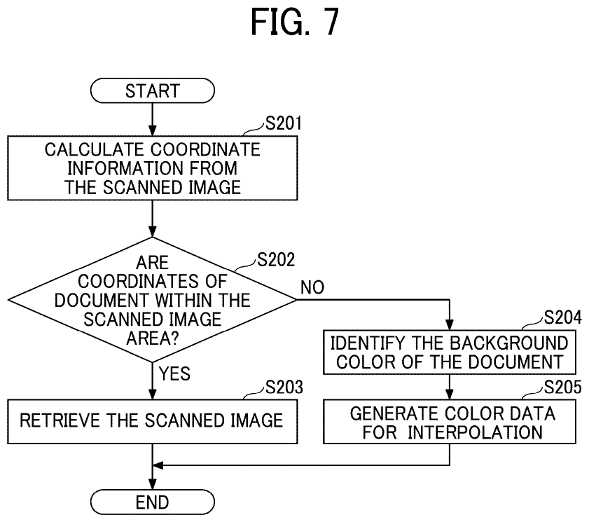

FIG. 7 is a flowchart of missing area interpolation processing in an image processing apparatus 1 according to a second embodiment of the present disclosure. The following processing is performed by the CPU 11 of the image processor 10 in the image processing apparatus 1, indicating that the processing is executed by circuitry. The interpolation color determination unit 4 of the image processing apparatus 1 identifies or determines the background color of the document 60 in the scanned image 50 and identifies the color for interpolating the missing area R1 of the document 60 based on the luminance value of the background color. Like reference signs are applied to components identical or corresponding to components described above, and redundant description is omitted.

In step S201, the image processing apparatus 1 calculates the coordinate information of the scanned image 50.

When the coordinates of the document 60 are within the scanned image 50 (Yes in step S202), the image processing apparatus 1 retrieves the scanned image 50 from a memory address corresponding to the calculated coordinates of the document 60 in the storage unit 6 (step S203).

When the coordinates of the document 60 are not within the scanned image 50 (No in step S202), the interpolation color determination unit 4 identifies or determines the background color of the document 60 (step S204). The background color may be identified by, for example, creating a histogram of pixel colors based on the values of all pixels in the scanned image 50 and selecting the color with the highest frequency as the background color.

The interpolation color determination unit 4 generates color data to interpolate the missing area R1 based on the identified background color of the document 60 (step S205). The color data can be generated by comparing the luminance value of the background color of the document 60 with a threshold. If the luminance value is lower than the threshold, the background color is set to white, for example. If the luminance value is greater than the threshold, the background color is set to black. However, when the scanned image 50 is output for copying, the color data may be set to gray to reduce ink consumption.

In the image processing apparatus 1 of the present embodiment, the interpolation color determination unit 4 identifies the background color of the document 60. When the background color of the document 60 has a low luminance value, such as black, the interpolation color determination unit 4 determines the interpolation color for the missing area R1 based on the background color of the document 60, for example, white. This configuration facilitates the user's determination of whether any part of the document 60 is missing in a scanned image 50.

### Third Embodiment

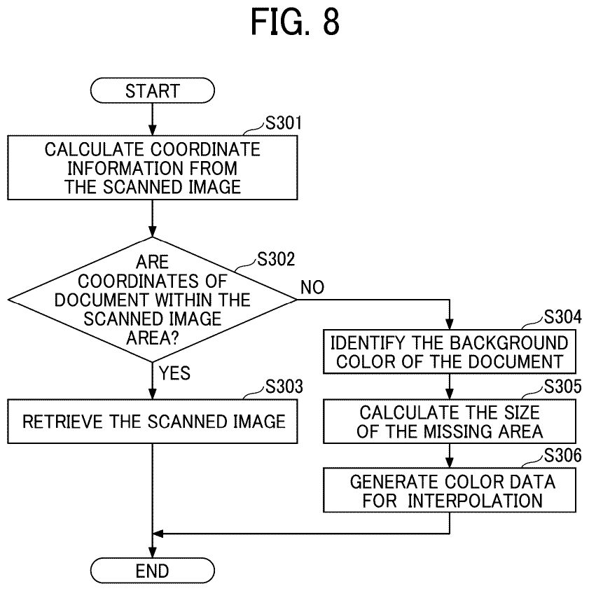

FIG. 8 is a flowchart of missing area interpolation processing in an image processing apparatus 1 according to a third embodiment of the present disclosure. The following processing is performed by the CPU 11 of the image processor 10 in the image processing apparatus 1, indicating that the processing is executed by circuitry. The missing area detection unit 3 of the image processing apparatus 1 calculates the size of the missing area R1 of the document 60. The interpolation color determination unit 4 determines a color (i.e., the interpolation color) for interpolating the missing area R1 of the document 60 based on the size of the missing region R1 calculated by the missing area detection unit 3. Like reference signs are applied to components identical or corresponding to components described above, and redundant description is omitted.

In step S301, the image processing apparatus 1 calculates the coordinate information of the scanned image 50.

When the coordinates of the document 60 are within the scanned image 50 (Yes in step S302), the image processing apparatus 1 retrieves the scanned image 50 from a memory address corresponding to the calculated coordinates of the document 60 in the storage unit 6 in step S303.

When the coordinates of the document 60 are not within the scanned image 50 (No in step S302), the interpolation color determination unit 4 identifies or determines the background color of the document 60 (step S304). The missing area detection unit 3 calculates the size of the missing area R1 of the document 60 (step S305).

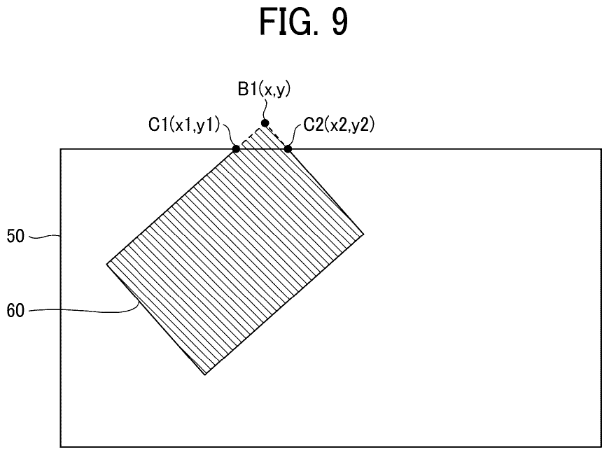

A method for calculating the size of the missing region R1 is described with reference to FIG. 9. FIG. 9 is a diagram for describing a method for calculating the size of a missing area R1 in an image processing apparatus 1 according to the third embodiment.

In FIG. 9, the coordinates of vertex B1 included in the missing area R1 of the document 60 are set to (x, y). Point C1 and point C2 are intersection points where the missing area R1 meets the scanned image 50. The coordinates of the point C1 and the point C2 are (x1, y1) and (x2, y2), respectively.

The missing area R1 has an area S, which is the area enclosed by the vertex B1, the point C1, and the point C2. The missing area R1, which is a triangle, is given by the following formula (1).

$$\begin{matrix}[ Formula 1 ] & \\ S = \frac{\sqrt{{( x - x 1 )}^{2} + {( y - y 1 )}^{2}} \times \sqrt{{( x 2 - x )}^{2} + {( y 2 - y )}^{2}}}{2} & ( 1 )\end{matrix}$$

Subsequently, the interpolation color determination unit 4 generates color data for interpolating the missing area R1 (step S306). The interpolation color determination unit 4 determines an interpolation color for the missing area R1 of the document 60 based on the size of the missing area R1 and the background color of the document 60. If the size of the missing area R1 is below a predetermined value, the interpolation color determination unit 4 sets the interpolation color for the missing area R1 to be the same as the background color of the document 60.

In the image processing apparatus 1 of the present embodiment, the interpolation color determination unit 4 determines an interpolation color for the missing area R1 of the document based on the size of the missing area R1. A smaller missing area R1 means a lower likelihood of printing loss. In this case, the interpolation color determination unit 4 sets the interpolation color for the missing area R1 to the background color of the document 60. Since the background color of the document 60 is often white, the ink consumption of ink during output can be reduced. Setting the interpolation color for the missing area R1 to the background color of the document 60 achieves good image quality.

### Fourth Embodiment

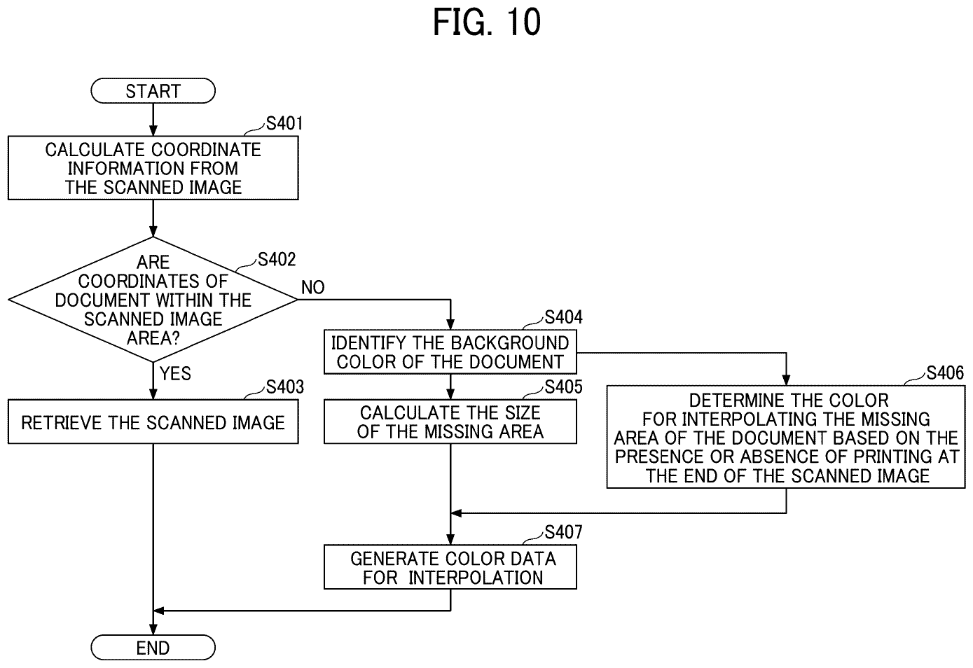

FIG. 10 is a flowchart of missing area interpolation processing in an image processing apparatus 1 according to a fourth embodiment of the present disclosure. The following processing is performed by the CPU 11 of the image processor 10 in the image processing apparatus 1, indicating that the processing is executed by circuitry. The interpolation color determination unit 4 of the image processing apparatus 1 determines an interpolation color for the missing area R1 of the document 60 based on presence or absence of printing in a predetermined area R2 (or an end area) at an end of a scanned image 50. Like reference signs are applied to components identical or corresponding to components described above, and redundant description is omitted.

In step S401, the image processing apparatus 1 calculates coordinate information of the scanned image 50.

When the coordinates of the document 60 are within the scanned image 50 (Yes in step S402), the image processing apparatus 1 retrieves the scanned image 50 from a memory address corresponding to the calculated coordinates of the document 60 in the storage unit 6 in step S403.

When the coordinates of the document 60 are not within the scanned image 50 (No in step S402), the interpolation color determination unit 4 identifies or determines the background color of the document 60 (step S404). The missing area detection unit 3 calculates the size of the missing area R1 of the document 60 (step S405). The interpolation color determination unit 4 determines an interpolation color for the missing area R1 of the document 60 based on presence or absence of printing in the predetermined area R2 at an end of a scanned image 50.

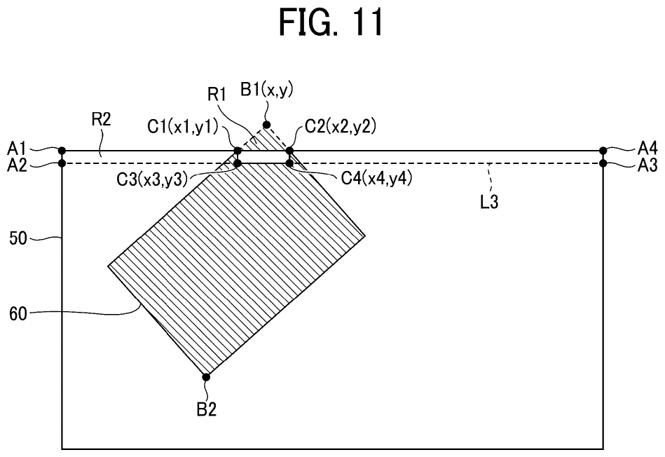

FIG. 11 is a diagram for explaining a method for determining a color for interpolating a missing area R1 of a document 60 based on presence or absence of printing at the end of a scanned image 50 in an image processing apparatus 1 according to a fourth embodiment of the present disclosure.

In FIG. 11, a predetermined area R2 at the end of the scanned image 50 is defined as an area enclosed by points A1, A2, A3, and A4. Point C1 and point C2 are intersection points where the missing area R1 meets the scanned image 50. The point C3 is the intersection of a line L3 and the perpendicular line drawn from the point C1 to the line L3, where the line L3 connects the point A2 and the point A3. A point C4 is the intersection of the line L3 and the perpendicular line drawn from the point C2 to the line L3.

The coordinates of the point C1 and the point C2 are (x1, y1) and (x2, y2), respectively.

The coordinates of the point C3 and the point C4 are (x3, y3) and (x4, y4), respectively.

If printing is present in the predetermined area R2, printing may also be present in the missing area R1. Whether printing is present at the end of the scanned image 50 is determined based on whether printing is present in the predetermined area R2.

The presence or absence of printing in the predetermined region R2 is determined based on, for example, the edge intensity, which indicates the degree of an edge, obtained by differentiating the pixel values of adjacent pixels for each pixel in the predetermined area R2.

It can be determined that printing is present if the edge intensity is high, and that printing is absent if the edge intensity is low.

Subsequently, the interpolation color determination unit 4 generates color data for interpolating the missing area R1 (step S407). When the size of the missing area R1 is equal to or larger than the predetermined value or when it is determined that printing is present in the predetermined area R2, the interpolation color determination unit 4 generates color data for interpolating the missing area R1 based on the background color of the document 60 identified as in step S205. Specifically, the color data can be generated by comparing the luminance value of the background color of the document 60 with a threshold. If the luminance value is lower than the threshold, the background color is set to white, for example. If the luminance value is greater than the threshold, the background color is set to black. However, when the scanned image 50 is output for copying, the color data may be set to gray to reduce ink consumption.

If the size of the missing area R1 is less than a threshold, and it is determined that printing is absent in the predetermined area R2, the interpolation color determination unit 4 sets the interpolation color for the missing area R1 to be the same as the background color of the document 60.

In the image processing apparatus 1 of the present embodiment, the interpolation color determination unit 4 determines an interpolation color for the missing area R1 of the document 60 based on the size of the missing area R1 and the presence or absence of printing in the predetermined area R2 at the end of the scanned image 50. The interpolation color determination unit 4 can set the color for interpolating the missing area R1 to be the same as the background color of the document 60, if the size of the missing area R1 is less than a threshold and printing is determined to be absent in the predetermined area R2.

The embodiments have been described above; however, the present disclosure is not limited to the above-described embodiments and can be modified and improved in various ways within the scope of the disclosure.

Each of the functions of the described embodiments may be implemented by one or more processing circuits or circuitry. Processing circuitry includes a programmed processor, as a processor includes circuitry. A processing circuit also includes devices such as an application c integrated circuit (ASIC), a digital signal processor (DSP), a field programmable gate array (FPGA), and conventional circuit components arranged to perform the recited functions.

Aspects of the present disclosure are as follows, for example.

### Aspect 1

An image processor comprising circuitry (e.g., the missing area detection unit) obtains a scanned image from a scanner; and detects a missing area of the document in the scanned image, determines a background color of the document in the scanned image. The circuitry (e.g., an interpolation color determination unit) determines whether to use the background color of the document as an interpolation color for interpolating the missing area of the document in the scanned image.

### Aspect 2

In the image processor according to Aspect 1, the circuitry (e.g., the interpolation color determination unit) is further configured to determine the interpolation color based on a luminance of the background color of the document.

### Aspect 3

In the image processor according to Aspect 1 or 2, the circuitry (e.g., the missing area detection unit) further calculates a size of the missing area of the document; and the interpolation color determination unit further determine the interpolation color based on the size of the missing area of the document.

### Aspect 4

In the image processor according to Aspect 3, the circuitry (e.g., the interpolation color determination unit) further determines presence or absence of printing in an end part of the scanned image; and determines the interpolation color based on the presence or absence of the printing.

### Aspect 5

In the image processor according to any one of Aspects 1 to 4, the circuitry (e.g., an inclination correction unit) further obtains a degree of an inclination of the document in the scanned image relative to a horizontal component of the scanned image; and corrects the inclination of the document based on the degree of the inclination.

### Aspect 6

In the image processor according to any one of Aspect 1 to 5, the missing area of the document has a triangular area extending beyond the scanned image.

### Aspect 7

An image forming apparatus includes the image processor according to any one of Aspects 1 to 6; a scanner to scan the image to obtain the scanned image; and a plotter to form an image based on the scanned image on a medium.

### Aspect 8

An image processing method includes obtaining a scanned image from a scanner; detecting a missing area of the document in the scanned image; determining a background color of the document in the scanned image; and determining whether to use the background color of the document as an interpolation color for interpolating the missing area of the document in the scanned image.

### Aspect 9

A non-transitory recording medium storing multiple instructions which, when executed by one or more processors, causes the one or more processors to perform a method. The method includes obtaining a scanned image from a scanner; detecting a missing area of the document in the scanned image; determining a background color of the document in the scanned image; and determining whether to use the background color of the document as an interpolation color for interpolating the missing area of the document in the scanned image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-c integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processor comprising circuitry configured to:
obtain a scanned image from a scanner;
detect a missing area of the document in the scanned image;
determine a background color of the document in the scanned image; and
determine whether to use the background color of the document as an interpolation color for interpolating the missing area of the document in the scanned image.

2. The image processor according to claim 1,
wherein the circuitry is further configured to determine the interpolation color based on a luminance of the background color of the document.

3. The image processor according to claim 1,
wherein the circuitry is further configured to:
calculate a size of the missing area of the document; and
determine the interpolation color based on the size of the missing area of the document.

4. The image processor according to claim 3,
wherein the circuitry is further configured to:
determine presence or absence of printing in an end part of the scanned image; and
determine the interpolation color based on the presence or absence of the printing.

5. The image processor according to claim 1,
wherein the circuitry is further configured to:
obtain a degree of an inclination of the document in the scanned image relative to a horizontal component of the scanned image; and
correct the inclination of the document based on the degree of the inclination.

6. The image processor according to claim 1,
wherein the missing area of the document has a triangular area extending beyond the scanned image.

7. An image forming apparatus comprising:
the image processor according to claim 1;
a scanner to scan the image to obtain the scanned image; and
a plotter to form an image based on the scanned image on a medium.

8. An image processing method comprising:
obtaining a scanned image from a scanner;
detecting a missing area of the document in the scanned image;
determining a background color of the document in the scanned image; and
determining whether to use the background color of the document as an interpolation color for interpolating the missing area of the document in the scanned image.

9. A non-transitory recording medium storing multiple instructions which, when executed by one or more processors, causes the one or more processors to perform a method, the method comprising:
obtaining a scanned image from a scanner;
detecting a missing area of the document in the scanned image;
determining a background color of the document in the scanned image; and
determining whether to use the background color of the document as an interpolation color for interpolating the missing area of the document in the scanned image.
